(19) United States
(12) Patent Application Publication
(10) Pub. No.: US 2011/0055268 A1
(43) Pub. Date: Mar. 3, 2011

(54) Search system based on structured natural languages

(76) Inventor: Chen-Yu Sheu, Irvine, CA (US)

(21) Appl. No.: 12/583,839

(22) Filed: Aug. 27, 2009

(51) Int. Cl. G06F 17/30; G06F 17/21

(52) U.S. Cl. 707/780; 704/9; 707/E17.015

(57) ABSTRACT

This invention is related to an SNL (Structured Natural Language) based search system (SNLSS) that allows Internet users to search services (tools, database, online services, etc.) based on problem statements expressed in one or more structured natural languages.

### BACKGROUND OF THE INVENTION

1. Field of the Invention

This invention is related to an SNL (Structured Natural Language) based search system (SNLSS) that allows Internet users to search services (tools, database, online services, etc.) based on problem statements expressed in one or more structured natural languages.

2. Description of the Related Art

The commercial world is mostly about demands and supplies. In most cases demands trigger supplies, and in some cases supplies create demands. A more general concept for needs may be problems, and that for supplies may be solutions.

The Internet has provided a global infrastructure to connect problems with solutions. For example eBay has done a great job on auctions. A keyword-based search engine such as Google may be considered as a special problem solver that solves the problem: Find (Web) documents that contain the keywords provided by the user. A Question/Answering (Q&A) system may be considered as another special problem solver that solves the problem: Find answers for the question (based on the documents collected by the system).

Both keyword-based search engines and Q&A system have done an excellent job for the problems they try to solve. But from the view point of Problem Solving, they are far from being sufficient. It can be easily seen that not every problem falls into the two general categories we talked about. Any computer scientist may easily come up the following list:
1. Computational Problems and other Mathematical Problems. Solving such problems require computation to be involved. Some initial attempts have been made (e.g., Wolfram|Appha, http://www.wolframalpha.com/), but lots more need to be done in this space.
2. Database Search Problems such as Find the supermarkets carrying apples at less than 2 dollars a pound. Deep webs usually work by themselves and they are not connected (Not because they cannot be, but perhaps because they do not want to be.)
3. Synthesis Problems such as Build a program that takes a set of numbers and returns them in increasing order. Automatic synthesis is general is hard and remains to be a goal to be accomplished.
4. Reasoning Problems such as What can be derived from this set of facts? Like automatic synthesis, automatic reasoning may be hard.
5. Data Analysis Problems such as What are the common patterns shown in this set of images? There are a lot of approaches that we may take to solve this problem; but this is not a problem addressed by search engines or Q&A systems.
6. “Personal” Problems such as I know person A and person B but they don't like each other, how can I put them to work? This may not be a scientific problem and its solution may very much reply on experiences, social considerations, etc.

Our main point is not to classify all the problems. What actually interests us is matching problems with solutions. The Internet does provide us an infrastructure to connect problems and solutions, but we may have not fully utilized this infrastructure. So far it has been useful for trading. If we can extend the concept of trading from goods to problems and buyers to solutions, we may have a new story for the Internet.

### SUMMARY OF THE INVENTION

For purposes of summarizing the invention, certain aspects, advantages and novel features of the invention have been described herein. It should be understood that not necessarily all such aspects, advantages or features will be embodied in any particular embodiment of the invention.

This invention provides an Internet search system that allows users to search for services (tools, content, online services, etc.) by composing a problem statement in a structured natural language. This is different from traditional search systems in which user needs are expressed in terms of keywords. This is also different from traditional Question and Answering (Q&A) systems in which user needs are expressed as questions.

### DETAILED DESCRIPTION OF THE PREFERRED EMBODIMENT

The following subsections describe a semantic search system that embodies various inventive features. The various inventive features can be implemented differently than described herein. Thus, the following description is intended only to illustrate, and not limit, the scope of the present invention.

### Architecture of SNLSS

The Structured Natural Language based Search System (SNLSS) provides users with a problem-driven interface to search for a service according to users' problems, where a service may be an online service, an online database, or a web service that provides its API for composing more complex services. The architecture of SNLSS is shown in FIG. 1:
1. Query Sentence User Interface 110, a query interface through which a user can pose a query sentence in a structured natural language.
2. Capability Sentence User Interface 120, an interface through which a solution provider can pose a capability sentence in a structured natural language.
3. Capability Base 130 that sores all capability sentences provided by service providers.
4. Query-Capability Matcher 140, that matches a query sentence with a set of capability sentences in the same structured language and returns services whose capability can match the query sentence.

### Structured Natural Languages (SNL)

An SNL is a subset of natural language whose sentences are imperative sentences of natural language with at least one additional constraint on its grammar. For example we can define one SNL (called SNL-1) whose structure is defined by the following, where reserved words are expressed in upper-case letters:

[GIVEN <noun phrase> [AS $<variable-id>]]*
[WITH <noun phrase> [AS $<variable-id>]]*
<verb phrase>
[THAT <condition clause> AND THAT <condition clause> ....]

We will later refer to “[GIVEN <noun phrase>]” as a GIVEN phrase, and “[WITH <noun phrase>]” as a WITH phrase. In the above, a condition clause modifies a noun specified earlier in the sentence, the notation [ . . . ] means the text pattern enclosed by the pair of brackets is optional, the notation [ . . . ]*designates the text pattern enclosed by the pair of brackets may occur zero, one or more times, and “AS $<variable-id>” defines a variable whose name has to be preceded by ‘$’. Variables, once defined, can be used in the verb phrase and any condition clause. Any variable defined in a GIVEN phrase can be used in a WITH phrase.

Following are some example sentences described in SNL-1. Note that a sentence may be a query sentence or a capability sentence, depending on who (service consumer or service provider) enters the sentence.

Example 1: Given a dataset of images, classify blobs of images in a dataset.
GIVEN a dataset of images
Classify blobs of images
Example 2: Given an image dataset, identify blob clusters that look like a satellite.
GIVEN a dataset of images AS $x
Identify blobs of images of $x
THAT looks like a satellite
Example 3: Given a dataset, identify blob clusters not overlapping with other blob clusters.
GIVEN a dataset of images
Identify blobs of images
THAT are not overlapping
Example 4: Given a dataset, find distribution of some variables over others.
GIVEN a dataset of variables [x1, x2, . . . , x10]
Find distribution of x5 over [x1, x4]
Example 5: Given a set of video clips, find those containing a scene similar to a given scene.
GIVEN a dataset of video clips
GIVEN a video clip $x
Find clips
THAT are similar to $x
In the above, $x is a variable. In SNL, a variable is preceded by a dollar sign (‘$’) and can be created with a GIVEN phrase.

### Example 6: [Text] Q&A?

GIVEN a dataset of web pages
Find a web page
THAT containing an answer for ‘ . . . ’

FIG. 2 shows one embodiment of a computer-implemented process of composing an SNL1 sentence. If the user wants to define any GIVEN phrase, the process proceeds to a block 210, where the user specifies a noun phrase. If the user wants to define any WITH phrase, the process proceeds to a block 220, where the user specifies a noun phrase. At a block 230, the process asks the user to specify a verb phrase. If the user wishes to specify a condition clause, then the process proceeds to a block 240, where the user is prompted to specify a condition clause.

Below is another SNL; let us call it SNL-2:

### FIND PERSON

[THAT <condition clause> AND THAT <condition clause> . . . ]
Example 7: Who invented telephone?

### FIND PERSON

THAT invented telephone

Yet below is another SNL; let us call it SNL-3:

### FIND PLACE

[THAT <condition clause> AND THAT <condition clause> . . . ]

### Example 8: Where is California?

### FIND PLACE

### THAT is California

### Service Discovery

Service discovery in SNLSS contains two phases: service registration and service matching.
1. Service Registration: To have a better chance of being discovered by SNLSS, a service provider can register in advance. Service providers have to provide service information, including URL, namespace, capability sentence(s), etc.
2. Service Matching: When user poses a query sentence, the Query-Capability Matcher handles the matching between the query sentence and the available capability sentences stored in the Capability Base that are expressed in the same SNL and determines if a service has the capability to answer the query.

FIG. 3 shows one embodiment of a computer-implemented process of SNLSS. At a block 310, a user chooses a structured natural language to compose a query sentence. At a block 320, a user composes a query sentence in the structured natural language selected. The sentence is matched against the capability sentences in the same structured natural language stored in a block 330. Finally all matched solutions are listed in a block 340.

### BRIEF DESCRIPTION OF THE DRAWINGS

FIG. 1 illustrates one embodiment of the search system

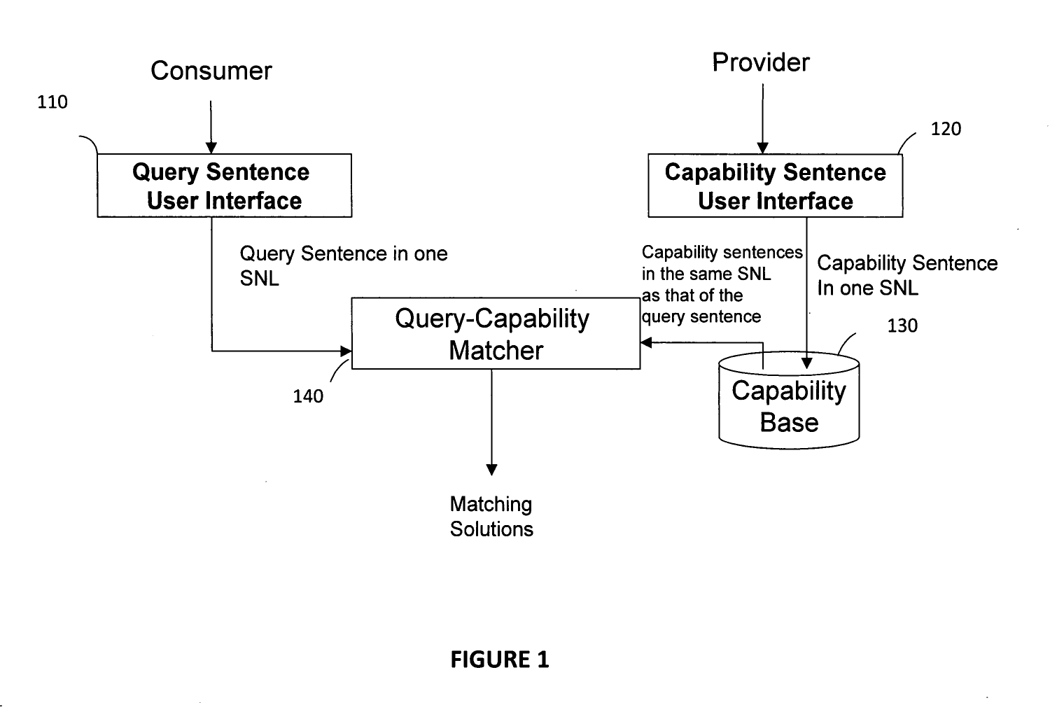

FIG. 2 illustrates one embodiment of the sentence composition process for an SNL

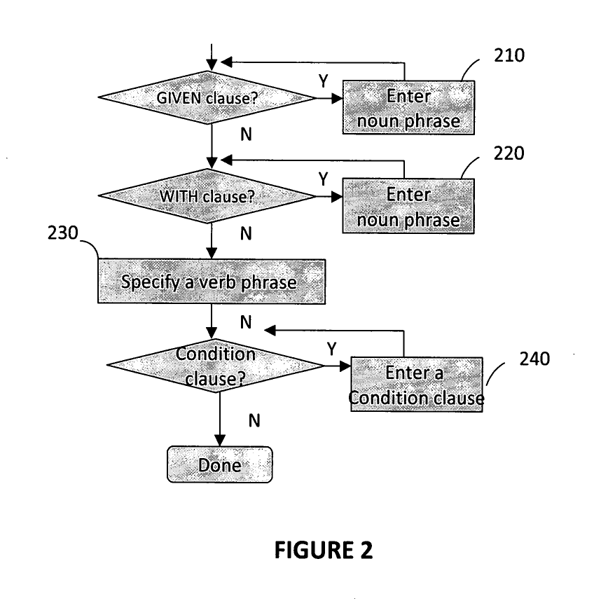

FIG. 3 illustrates one embodiment of the control flow of the system

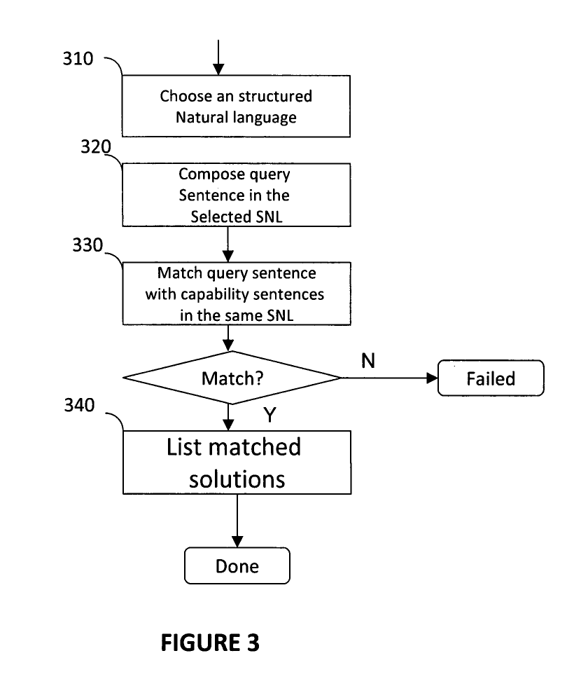

What is claimed is:

1. A semantic search system, the system comprising
a computer interface that can be connected to a user that allows the user to compose a query sentence in one or more structured natural languages;
a collection of computer programs where each of them parses query sentences in a specific structured natural language;
a collection of computer programs where each of them searches the Internet and returns possible services based on the user query sentence for each specific structured natural language.

2. The system of claim 1, further comprising a computer interface that can be connected to a service provider to compose a capability sentence of a service in a structured natural languages and to register the service with the system.

3. The system of claim 1, further comprising a storage that stores the capability sentences of all registered services.

4. The system of claim 1, further comprising allowing a user to define a sentence as a variable to be used in another sentence.

5. The system of claim 1, further comprising a collection of computer programs where each of them matches a user query sentence in a structured query language with the capability sentences expressed in the same structured query language and returns those services whose capability can match the user query sentence.

6. The system of claim 1, further comprising a ranking module that ranks the services returned.

7. The system of claim 1, further comprising a rating module that general users can provide their reviews about a service.

8. The method of claim 1, further comprising that multiple structured capability sentences may be defined for a service.

9. The system of claim 1, further comprising a computer program that passes a user query sentence to a matching service for execution.

10. The system of claim 1, further comprising a computer program that receives and delivers to the user the result returned from a matching service after the corresponding user query sentence is executed by the service.

11. A computer-implemented method of composing a user query sentence or a service capability sentence in a structured natural language, the method comprising that prompting a user to specify a verb phrase

12. The method of claim 11, further comprising that prompting the user to specify an optional noun phrase for a “GIVEN” phrase.

13. The method of claim 11, further comprising that prompting the user to specify an optional noun phrase for a “WITH” phrase.

14. The method of claim 11, further comprising that prompting the user to specify an optional condition clause.

15. A computer-implemented method of matching a user query sentence in a structured natural language and a capability sentence, the method comprising:
Matching the GIVEN phrases;
Matching the WITH phrases;
Matching the verb phrases; and
Matching the condition clauses.

16. The method of claim 15, further comprising that a query sentence may be matched by combining more than one capability sentences.

17. The method of claim 15, further comprising that a service whose capability sentence that partially matches that of the structured query sentence is returned as a result.

18. A computer-implemented method of problem solving, the method comprising:
prompting a user to choose a structured natural language;
prompting a user to compose a query in the selected structured natural language;
matching the query sentence with the capability sentence(s) expressed in the same structured natural language of each service registered with the system and returns those services whose capability may match the user query sentence;
prompting a user to select one or more matching services.

19. The method of claim 18, further comprising that
instructing the user how to use a matching service after the service is selected;
the user subscribes a matching service as instructed.
